(19) United States
(12) Patent Application Publication
(10) Pub. No.: US 2024/0409256 A1
(43) Pub. Date: Dec. 12, 2024

(54) DEVICE AND METHOD FOR PRODUCING SACHETS FILLED WITH LIQUID OR PASTY FILLING MATERIAL

(71) Applicant: Albert Handtmann Maschinenfabrik GmbH & Co. KG, Biberach (DE)

(72) Inventors: Markus SCHLIESSER, Wain (DE); Manfred BAECHTLE, Schemmerhofen (DE)

(21) Appl. No.: 18/737,567

(22) Filed: Jun. 7, 2024

(30) Foreign Application Priority Data
Jun. 9, 2023 (EP) 23 178 420.8

(51) Int. Cl. B65B 9/24; B65B 25/00; B65B 61/00

(52) U.S. Cl. CPC B65B 9/24; B65B 25/001; B65B 61/007

(57) ABSTRACT

The disclosure relates to a device and a method for producing sachets filled with liquid or pasty filling material, in particular food products. The device has a coextrusion device for coextruding a strand of a wrapping material filled with the filling material and opposing circulating division plungers between which the strand can be transported and which can transport the filling material, when they move towards each other on their orbital path, strip off the wrapping material at a division point and can press the wrapping material to be flat at the division point to form a sachet.

### CROSS REFERENCE TO RELATED APPLICATION

The present application claims priority to European Patent Application No. 23 178 420.8 filed on Jun. 9, 2023. The entire contents of the above-listed application are hereby incorporated by reference for all purposes.

### TECHNICAL FIELD

The disclosure relates to a device and a method for producing sachets filled with liquid filling material, in particular food products.

### BACKGROUND

It is already known from the prior art to package a product, e.g. cosmetics, food, etc., in so-called sachets. Sachets are packages which have flattened end sections at their ends. Such packaging is usually produced using tubular bag machines. FIG. 8, for example, shows how such a vertical tubular bag machine works. For this purpose, a packaging wrapping is produced, wound around a shaped pipe and closed by means of a longitudinal sealing seam. The tube thus produced is filled with the product to be packaged, e.g. ketchup, via the shaped pipe and sealed at a transverse sealing seam using a sealing plunger. The sealing plungers usually have to remain closed for a certain amount of time during the filling process, which reduces production output. On the other hand, a sufficient sealing time is necessary to create sufficient strength at the sealing point. The wrapping also often sticks together during sealing. Overall, the method described above is complex and only suitable to a limited extent when using biodegradable wrapping materials (co-extruded wrappers), such as alginate wrappers, pectin wrappers or collagen wrappers. FIG. 9 schematically shows a horizontal flow-wrapping machine that has similar problems to the vertical form, fill and seal machine shown in connection with FIG. 8. In particular, no liquid can be packaged with the horizontal flow-wrapping machine.

### SUMMARY

On this basis, the problem underlying the present disclosure is to provide a device and a method for the simplified, more efficient and environmentally friendly production of scaled sachets filled with liquid or pasty filling material, in particular with liquid or pasty food products, which allow liquid-tight packaging.

According to the disclosure, this problem is solved by a device for producing sachets filled with liquid or pasty filling material, comprising: a coextrusion device for coextruding a strand from a wrapping material filled with the filling material; and opposite circulating division plungers, between which the strand is configured to be transported and which, when the division plungers move towards one another on their orbital path, are configured to strip off the wrapping material at a division point and press the wrapping material to be flat at the division point to form a sachet.

According to the disclosure, the device for producing sachets filled with liquid or pasty filling material, in particular food products, comprises a coextrusion device for coextruding a strand of a wrapping material (casing material) filled with the filling material. Such a coextrusion device extrudes the filling material or the food product and the wrapping material simultaneously. Such a coextrusion device is also particularly suitable for extruding a wrapping material, in particular a gel, which can be cured by means of a fixing solution, preferably a biodegradable wrapping material, such as an alginate gel, pectin gel or collagen gel. An alginate gel is particularly preferred for food products. A calcium chloride solution, for example, serves as a fixing solution.

Furthermore, the device has opposing circumferential division plungers, between which the strand produced by the coextrusion device can be transported. The division plungers can strip off the filling material, in particular the food product, from the wrapping material at a division point when they move towards each other on their orbital path and engage in the strand, and press the wrapping material, which is not yet fully cured at this point, flat at the division point to form a sachet.

As the opposing division plungers circulate, they are not aligned parallel to each other in the front deflection area (which faces the coextrusion device). This means that when they move towards each other in the deflection area-until they are essentially aligned parallel to each other again-they strip off the inner mass, i.e. the filling material, so that there is no inner mass but only a clean wrapping in the division point. The division point can thus be pressed cleanly and sealed liquid-tight. In the case of a curable wrapping material, the wrapping material is not fully cured in the division point, i.e. it is not fully cross-linked, so that the curable wrapping material on the upper and lower sides of the wrapping can bond together on the inside of the division point, in particular also homogeneously. This is possible because the division plungers engage in the coextruded strand and the packaging material, i.e. the film, is not produced in advance, as described in the prior art.

The device according to the disclosure thus allows the liquid-tight packaging of filling material due to the full-surface pressed smooth and crease-free division point.

Liquid here means, for example, a filling material with a viscosity of e.g. <=70,000 mPas at 20° C., thus e.g. also filling material that has a consistency such as ketchup or mustard, soup, shampoo, cream, honey, jam, etc., in particular e.g. <5000 mPas at 20° C. (e.g. also applesauce, baby food, salad dressing) and further, in particular e.g. <=1000 mPas at 20° C. (e.g. also juice, oil). However, the device is also suitable for producing sachets filled with pasty filling material with higher viscosities.

Although the division plungers could also be arranged circumferentially on a shaft, it is particularly preferred if the device has a transport device with opposing, circulating transport means, in particular transport belts or chains, on each of which the spaced division plungers are arranged. For example, about 1-100 division plungers are arranged per transport means. The opposing division plungers can be moved towards each other in the deflection area of the transport means, in particular the transport belts, in such a way that their flat pressing surfaces are initially aligned at an angle to each other when they engage in the strand. On further movement out of the deflection area, the division plungers then come to lie parallel to each other, such that the division point can be pressed to be flat. During the transition from the deflection area to an area in which the pressing surfaces of the division plungers are aligned parallel to each other, the filling material, in particular food products, is stripped off the wrapping material, as also described above. It is then particularly preferred that during transport of the sachets produced in this way in the transport direction, the division plungers can continue to press the division points, at least on a first section of the transport device. In this way, the division points can continue to cure during transportation in the transport device and leave the device in a stable state.

In this way, the sachets can be produced at a higher output than in the prior art, as several division elements are engaged simultaneously and thus the solidification process is not dependent on the portioning cycle.

The division plungers may each have a flat pressing surface. The flat pressing surface has no projections or depressions, but is smooth. It lies on the entire surface of the wrapping material during pressing. In this way, a particularly crease-free division point can be created so that no liquid can escape at the division point when the sachet is filled with liquid or low-viscosity filling material, in particular food products. The wrapping material can thus be pressed over the entire surface at the division point.

According to an embodiment, the pressing surface of the division plungers has a length which extends perpendicular to the transport direction T of the transport device and which is greater in comparison to the width of the extruded strand (i.e. greater than the diameter of the extrusion nozzle of the wrapping material). This ensures that a liquid-tight division point is created and, for example, essentially rectangular sachets are produced, while at the same time ensuring that the division plungers strip off the filling material or food product over the entire width of the sachet at the division point.

According to an embodiment, the coextrusion device has a filling pipe for discharging the filling material or food product, and an extrusion nozzle associated with the filling pipe and having a substantially annular extrusion gap for discharging the wrapping material. Preferably, the filling pipe projects beyond the extrusion gap over a distance X such that the wrapping material can be extruded through the extrusion gap onto the filling pipe and can at least partially solidify along the filling pipe, i.e. when, for example, a fixing solution is applied to the filling pipe. A configuration in which the filling pipe projects beyond the extrusion nozzle for the wrapping material is particularly preferred, as the distance between the filling pipe and the transport device can then be minimized. This has the advantage that the extruded material does not sag downwards and that the strand is separated at the earliest possible point in time.

According to an embodiment, the device can have a lubricant device for supplying a lubricant (e.g. water or a fixing agent) between the filling pipe and the extruded wrapping material. It has been shown that such a configuration is particularly suitable for the production of sachets, as the wrapping can then be gently produced on the filling pipe and removed from it. A fixing agent is preferably applied to the outside of the extruded wrapping upstream of the transport device.

According to an embodiment, the width b of the outlet opening of the filling pipe is greater than its height h₂, wherein the outlet opening has in particular an oval cross-section or a rectangular cross-section with rounded corners. This has the advantage that the product, in particular the food product, can already be extruded to be flat and thus the filling material can be more easily displaced by the division plungers and the wrapping can be better pressed. Another advantage is that when the upper wrapping material is brought together with the lower wrapping material during pressing, no creases are created which could possibly lead to weaker connections during the solidification process and thus to leaks after the sachets are separated from each other.

However, it is also advantageously possible for a pipe section to be formed on the end of the filling pipe facing the transport device, the width of the outlet opening of which is greater than the diameter h₁ of the filling pipe and the height h₂ of which is less than the diameter h₁ of the filling pipe. This means that, as described above, the outlet opening can in particular have an oval cross-section or a rectangular cross-section with rounded corners, wherein, however, standard co-extrusion devices can be used in which an additional pipe section is molded onto or attached to the existing filling pipe. Preferably, the cross-sectional area of the filling pipe and the molded pipe section is essentially the same, so that a uniform volume flow can be maintained.

According to a further embodiment, the transport means can be arranged one above the other and the lower circulating transport means can be longer than the one above it (longer when viewed in the transport direction). In this case, the produced sachets can be transported lying even further on the transport means and solidify further. Alternatively, the sachets can be transferred to a further lower transport means. In both embodiments, the sachets can also be separated, for example.

A device for applying a fixing agent is preferably arranged upstream of the circulating transport means, i.e. between the extrusion nozzle for the wrapping material and the transport device, when viewed in the transport direction. The fixing means already makes the wrapping sufficiently firm so that the plungers do not destroy the wrapping material during pressing. However, the wrapping material is still not completely cross-linked or gelled, so that a perfect material bond between the upper and lower wrapping material can be guaranteed during pressing.

According to an embodiment, the device has a separating device that separates successive sachets from one another in the area of the division point. Such a separating device can, for example, be arranged in or downstream of the transport device or, preferably, the separating device can also be integrated into the division plungers. In this case, a sharp blade can be permanently integrated into the division plunger. Alternatively, movable sharp blades can be integrated in the center of the division plungers, wherein this is moved, for example, by means of a gate for cutting off the portions.

The separating device can also be configured in such a way that the division points are not completely severed, but only perforated, e.g. via a perforating device.

The distance between the opposing division plungers is preferably adjustable, in particular the distance between the opposing transport means, so that the distance between the division plungers then also changes accordingly. This means that the distance and the contact pressure can be precisely adapted to the product to be produced. This is preferred due to the sensitive wrapping material and to ensure a proper division point.

Advantageously, the filling pipe of the coextrusion device overlaps spatially with the transport device, i.e. there is no distance between the end of the filling pipe and the end of the transport device facing the coextrusion device when viewed in the transport direction. This ensures close proximity so that the extruded strand does not sag and tear and the wrapping material is not yet fully cured.

Preferably, the outlet opening of the filling pipe is arranged in a deflection area between the transport means, in particular in an area viewed in the transport direction behind a plane perpendicular to the transport direction T, on which at least one of the front deflection points P of the transport belts lies, wherein the filling pipe can protrude so far in the transport direction that the plungers can run past the filling pipe. The deflection point is the foremost point of the transport means at which the transport means changes its direction of movement.

According to an embodiment, the distance between the opposing circulating transport means is smaller at the rear end viewed in the transport direction than at the beginning. This means that the division point can be pressed even more strongly during transportation using transport means.

According to the method according to the disclosure for producing sachets filled with liquid or pasty filling material, in particular food products, a strand of a curable wrapping material filled with filling material, in particular food products, is extruded via a coextrusion device. The strand is guided between circulating division plungers, wherein the circulating division plungers move towards each other, engage in the strand and strip off the filling material, in particular food product, from the wrapping material at a division point and press the not yet fully cured wrapping material into a sachet at the division point. The curable wrapping material can be a gel, in particular a biodegradable gel, preferably an alginate gel, pectin gel or collagen gel.

With the method according to the disclosure, sachets with a crease-free, smooth and thus tight division point can be produced in an improved manner such that liquids can also be packaged.

According to an embodiment, a transport device with opposing, circulating transport means, in particular transport belts or chains, on each of which several spaced division plungers are arranged, transports the separated sachets in transport direction T, wherein the division points are further pressed by the division plungers.

The produced, separated sachets have a rectangular, possibly square flat shape, i.e. the height of the sachets is smaller than the width; preferably the ratio of height to width is in a range of 1:1.5-1:20. The division points that border the front and back of the sachets are flat and extend over the entire width of the sachet.

The wrapping material can contain pieces of food, e.g. pieces of bell pepper or spices. This results in a particularly appealing appearance and a special taste, e.g. cream cheese coated with pieces of bell pepper.

Advantageously, the distance from the outlet opening of the filling pipe to a plane E1 which is perpendicular to the transport direction T and on which at least one of the front axes around which the transport means circulates is approximately 5-30 mm.

### BRIEF DESCRIPTION OF THE FIGURES

The present disclosure is explained in more detail below with reference to the following Figures.

FIG. 1 shows a perspective view of an embodiment of a device according to the present disclosure.

FIG. 2 shows a roughly schematic section of the embodiment shown in a perspective view in FIG. 1.

FIG. 3 shows schematically a side view and a top view of the filling pipe outlet on three different filling pipes according to the present disclosure.

FIG. 4 shows schematically the produced sachets in a chain and separate sachets.

FIG. 5a shows a schematic view of a transport means according to an embodiment of the present disclosure.

FIG. 5b shows a schematic perspective view of a division plunger.

FIG. 6 shows a cross-section of a coextrusion device according to the present disclosure.

FIG. 7 shows another embodiment with extended lower transport means and integrated separating unit.

FIGS. 8 and 9 show flow-wrapping machines according to the prior art.

### DETAILED DESCRIPTION

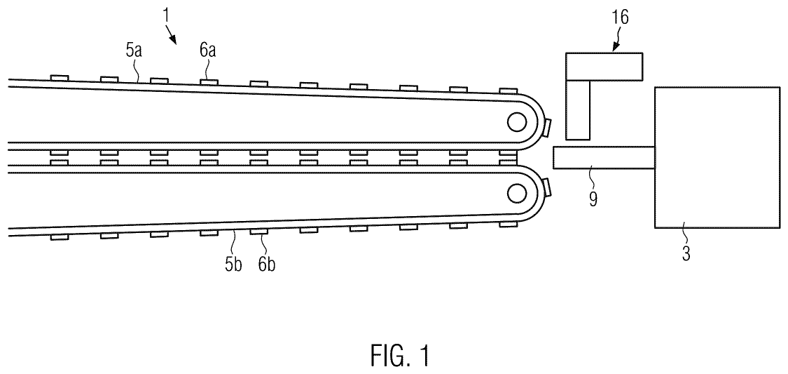

FIG. 1 shows a roughly schematic embodiment of a device 1 for producing sachets 2 filled with liquid or pasty filling material or food products. The following embodiments are explained in more detail with reference to a food product to be filled, but are equally suitable for other filling materials, i.e. non-food products.

The device has a coextrusion device 3 for coextruding a strand of wrapping material 15 filled with a food product 14. The liquid food product can be, for example, ketchup, mustard, jam or honey. Non-food products such as shampoo, cream, liquid detergent, etc. can also be considered as liquid filling material. However, filling material or food products with a higher viscosity can also be packaged tightly with the device according to the disclosure-here too, liquid-tight packaging is preferred so that the product does not dry out.

Alginate gel is particularly suitable as a curable wrapping material, alternatively pectin gel or collagen gel. Such materials are particularly preferred because they are biodegradable and also edible and the amount of plastic waste can be reduced. Such materials are commercially available e.g. as a paste or as a powder that is mixed with water.

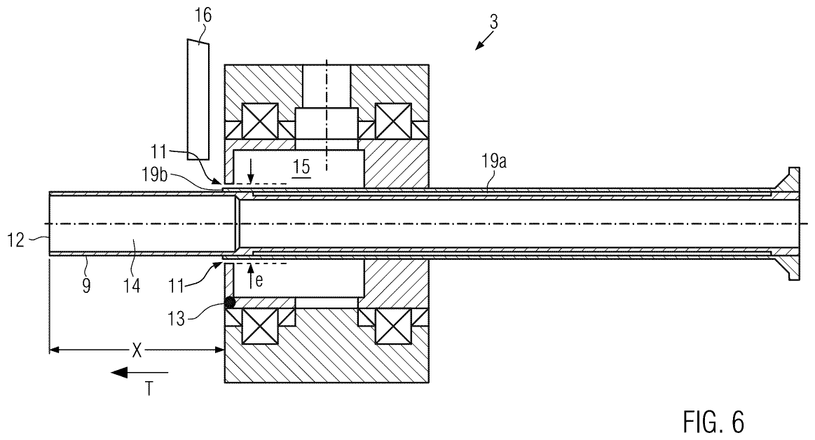

FIG. 6 shows a possible embodiment of such a coextrusion device 3. The coextrusion device 3 has a filling pipe 9 for discharging the food product 14 and an extrusion nozzle 13 associated with the filling pipe 9 with a preferably annular extrusion gap 11 for discharging the wrapping material 15. Although not shown here, there are coextrusion devices that discharge the wrapping material 15 directly onto the outer surface of the food product 14. However, this is difficult with liquid or low-viscosity materials. Thus, as shown in FIG. 6, a filling pipe is used which projects beyond the extrusion gap 11 over the section X in such a way that the wrapping material 15 is extruded through the extrusion gap 11 onto the filling pipe 9 and can thus solidify along the filling pipe 9 and can then be drawn off the filling pipe 9 together with the extruded food product 14. To ensure that the extruded wrapping material 15 already begins to solidify on the filling pipe 9, a device 16 (e.g., a fixing device) for applying a fixing agent can be arranged in the area of the section X of the filling pipe. A salt solution, in particular a calcium chloride solution, e.g. 10%, is suitable as a fixing agent.

Additionally or alternatively, the device can have a lubricant device 19 for supplying a lubricant between the filling pipe 9 and the discharged wrapping material 15. In this way, the slip value between the filling pipe and the discharged wrapping material can be minimized. Water, for example, can be added as a lubricant. The lubricant device comprises, for example, a feeding device 19a for the lubricant. The feeding device 19a is formed here as a channel in the filling pipe 9. For example, the channel runs in an annular shape in the wall of the filling pipe. In the area of the extrusion gap 11, a further annular gap 19b is arranged around the outer surface of the filling pipe 9. For this purpose, the filling pipe 9 has a smaller diameter in the area behind the further annular gap 19b than the filling pipe in an area in front of the further annular gap 19b. An internal injection of the lubricant between the discharged wrapping material and the surface of the filling pipe 9 can take place via the annular gap 19b. This allows the discharged wrapping material to slide easily on the filling pipe.

Due to the fact that the filling pipe 9 projects beyond the extrusion gap 11, it can be arranged with its outlet opening 12 particularly close to the transport device 4 arranged downstream in the transport direction T. In this case, the transport device has opposite circulating transport means 5a, 5b, here e.g. transport belts, on each of which spaced-apart division plungers 6a, 6b are arranged. Irrespective of this embodiment, for example 1-approx. 100 division plungers can be arranged on a circulating transport means. The circulating transport means 5a may be opposite the circulating transport means 5b. The division plungers 6a may form a first subset of the division plungers and the division plungers 6b may form a second subset of the division plungers. The division plungers 6a (and thus the first subset) may be arranged on circulating transport means 5a and the division plungers 6b (and thus the second subset) may be arranged on circulating transport means 5b. Thus, the division plungers may be opposing, e.g., the division plungers 6a may be opposite/oppose the division plungers 6b.

In this embodiment, the outlet opening 12 of the filling pipe 9 protrudes so far in the transport direction T that the outlet opening 12 of the filling pipe is arranged in a deflection area between the transport means, i.e. in this case in an area behind a plane E2 on which at least one of the front deflection points P of the transport belts lies and which runs perpendicular to the transport direction T, i.e. here perpendicular to the image plane. However, the filling pipe 9 only extends so far into the deflection area that there is no collision with the division plungers 6a, 6b. The distance from the outlet opening 12 to the plane E1, which is perpendicular to the transport direction T and on which at least one of the front axes Ala, Alb around which the transport means 5a, 5b circulate, is approximately 5-30 mm.

When the division plungers 6a, 6b circulate on the respective transport means 5a, 5b, they each pass the deflection point P and are not yet aligned parallel to each other in the deflection area between the planes E1 and E2. Due to the fact that the division plungers are not aligned parallel to each other, they strip off internal mass from the wrapping material when they are moved towards each other in the deflection area, so that there is no internal mass, but only a clean wrapping in the division point 8 when the division plungers 6a, 6b are then aligned parallel to each other and press the wrapping material 15. The division point 8 can thus be pressed cleanly and bonded (homogeneously). In the case of the curable wrapping material, the wrapping material is not yet fully cured in the division point, i.e. not yet fully cross-linked, so that the curable wrapping material on the top and bottom of the wrapping can bond in the division point. During pressing, the division plungers 6a, 6b have a distance s in the range of 0.1-0.5 mm, for example. This distance can still change in the transport direction T, for example, in that the distance between the transport means at one end facing the filling pipe is greater than at an opposite rear end or, depending on the application, equal or smaller. For example, the distance in the front and middle area can be in the range of 0.1-0.5 mm and in the rear area at a distance of 0.1-1 mm. The distance between the division plungers can be set independently of each other on both sides of the transport means, in particular by setting the distance between the transport means 5a, 5b.

During the transport of the pressed sachets 2 in transport direction T, the division points 8 are thus further pressed by the division plungers 6a, 6b, so that the division points 8 can continue to cure during transport and leave the transport device in a stable state.

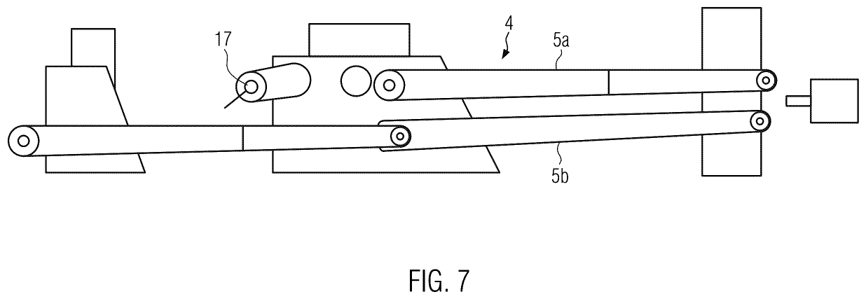

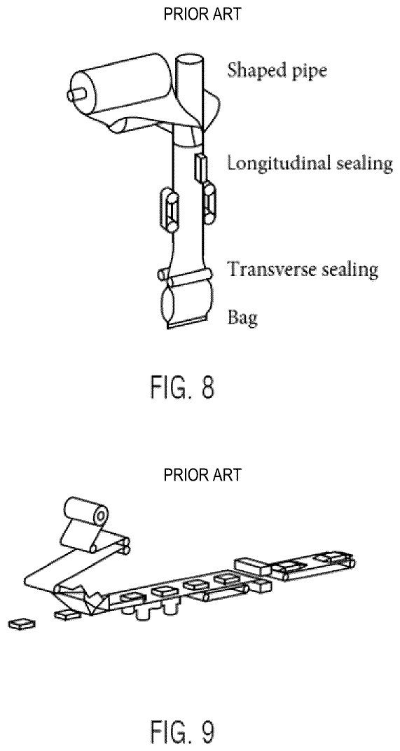

At the end of the transport device, as shown in FIG. 1, the sachets 2, as shown in FIG. 4, leave the device either as a sachet chain in which the individual sachets are still connected via the division point 8 or separated. The sachets 2 can be separated by a separating device 17 (FIG. 7) in the transport device 4 or subsequently into individual sachets at the division point 8. For this reason, it is important that the sachets are pressed to be flat and crease-free at the division point 8, such that no liquid or food product can escape from the sachet 2 via creases or channels. It is also possible that the separating device 17 is already integrated into the plunger 6a, 6b. The flat pressing surface is then divided into two flat pressing surfaces by the separating device or the knife.

However, as already described, it is also possible to perforate the connected sachets with a perforating device, not shown, in the area of the division point. The sachets can then leave the device as a chain and simply be cut off by the consumer.

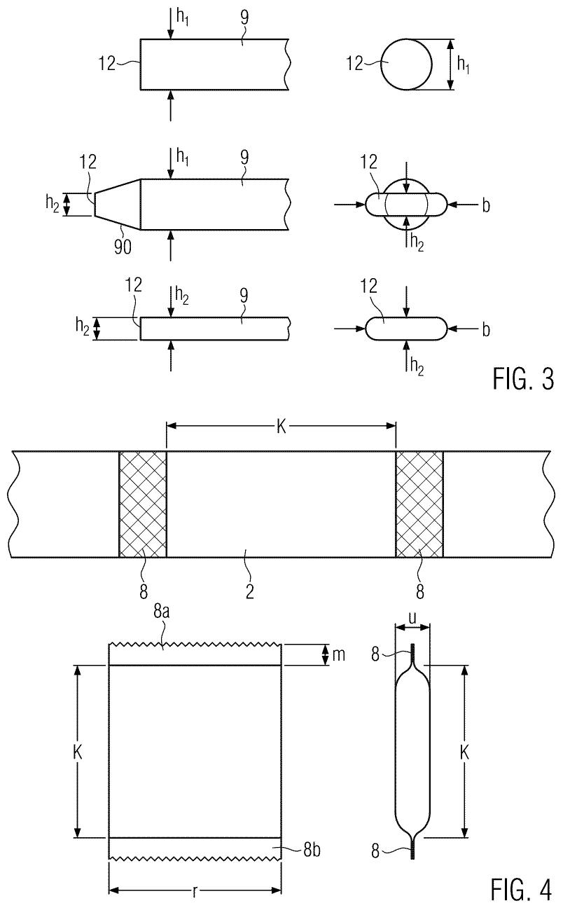

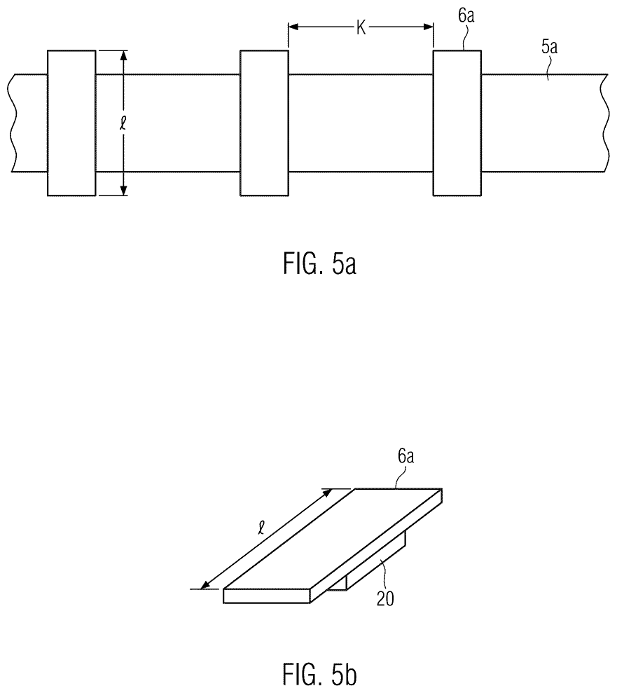

FIG. 3 shows a side view and a cross-section of different filling pipes according to the present disclosure. In the upper area of FIG. 3, a filling pipe 9 with a filling pipe diameter h₁ is shown. In the center of FIG. 3, a filling pipe 9 according to an embodiment of the present disclosure is shown. In contrast to the filling pipe 9 in the upper area of FIG. 3, the outlet opening 12 does not have a round cross-section, but a cross-section that has a height h₂ that is smaller than the width b of the outlet opening 12. Thus, the outlet opening 12 has a cross-section that is in particular oval or rectangular with rounded corners. The width b of the outlet opening 12 preferably extends in a direction parallel to the transport means, in this case the transport belts 5a and 5b, i.e. also along the length 1 of the division plungers 6a, 6b (see FIGS. 5a, 5b). This has the advantage that the food product can already be extruded to be flat and thus the food product can be displaced more easily by the division plungers 6a, 6b and the wrapping can then be pressed better and crease-free. Creases should be avoided, as creases can lead to weaker connections during the solidification process and also to leaks after the separation process of the sachets. In order to realize a corresponding outlet opening 12, for example, a pipe section 90 can be formed onto a hollow cylindrical filling pipe 9, the width of the outlet opening 12 of which is larger than the diameter of the filling pipe and the height of which is smaller than the diameter h₁ of the filling pipe. In this way, conventional extrusion heads with hollow cylindrical pipes can be used.

It is also possible, as shown in FIG. 3 below, that the entire filling pipe already has a corresponding oval or square (with rounded edges) cross-section.

FIGS. 5a and 5b show the division plungers 6a, 6b in greater detail (and specifically division plungers 6a). The division plungers 6a and 6b have a distance k from each other, which in turn essentially corresponds to the distance k between the division points 8 in the sachet 2 (see FIG. 4). The division plungers 6a, 6b each have a flat and preferably smooth pressing surface. This also contributes to a crease-free division point, so that no liquid can escape at the division point 8 in a sachet filled with liquid or low-viscosity food product.

Advantageously, the pressing surface of the division plungers 6a, 6b has a length l which extends perpendicular to the transport direction T of the transport device and which is greater than the width of the discharged strand, i.e. greater than the diameter e of the extrusion nozzle 13 (see, for example, FIG. 6). This ensures that essentially rectangular sachets are produced and at the same time ensures that the division plungers strip off the food product over the entire width r of the sachet at the division point and seal it securely.

The wrapping material 15 can thus be pressed over its entire surface at the division point 8. The division plungers 6a, 6b can be attached to the transport means 5a, 5b, e.g. the transport belt, via a connecting device 20, which is shown here only schematically in FIG. 5b. Plastic or stainless steel, for example, is particularly suitable as the material for the division plungers, as the surface does not stick to the wrapping material.

FIG. 7 shows an embodiment of the present disclosure. The embodiment shown here is essentially the same as the preceding embodiments, wherein, however, the lower transport means (e.g., belt) 5b is either longer than the upper transport means (e.g., belt) 5a or a further lower transport means 5b is adjacent to the first lower transport means 5b in the transport direction, so that the produced sachets 2, or the sachet product strand, can be transferred to the further lower belt. In this embodiment, it is possible for a separation process to take place in individual portions, while the transport only takes place on the lower belt. For example, a rotating separating device 17 can be used for this purpose. The fact that the lower transport means transports the separated products from production to the separation process also means that there is no transfer problem. The separation process takes place approximately in the middle of the division point 8 with little mechanical load. The transport element, in particular the division element, can also act as a support for the separating element during separation.

The method according to the disclosure is explained in more detail below with reference to FIGS. 1-7.

In the method according to the disclosure for producing filled sachets 2, a strand 10 of a curable wrapping material filled with food product 14 is first extruded via the coextrusion device 3.

Prior to separation, the wrapping material 15 is treated with a fixing solution via a device 16 for applying the fixing solution. The fixing solution can be sprayed via the device 16, for example, onto the wrapping material 15 applied to the filling pipe 9, e.g. in the form of a ring, and collected in the tray shown in FIG. 1. In particular, a calcium chloride solution is used as a fixing solution. As described above, a lubricant can also be introduced between the filling pipe and the wrapping material 15.

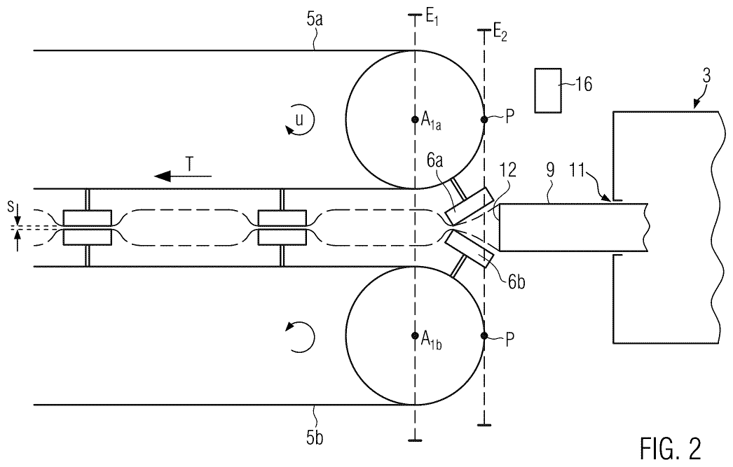

The strand 10 thus produced is discharged at the end of the filling pipe 9. The end of the filling pipe 9 protrudes as far as possible in the transport direction T, i.e. preferably into a deflection area of the transport means 5a, 5b. As can be seen in particular from FIG. 2, the division plungers 6a, 6b are at an angle α to each other when they engage in the strand 10 and then continue to move until they are finally aligned parallel to each other. Thus, when the division plungers 6a, 6b move towards each other in the deflection area until they are again essentially aligned parallel to each other, they strip off the food product 14, i.e. the inner mass, so that there is no food product but only a clean wrapping in the division point 8. At this point, the wrapping material 15 is not yet fully cured and cross-linked, so that the division point 8 can be neatly pressed and glued and the top and bottom sides bond in a material-locking manner. The sachets 2 thus produced are transported further in the transport direction T via the division plungers 6a, 6b and further pressed during transport. During transport in the transport device 4, the division points 8 can further solidify and stabilize.

The process is repeated and the subsequent division plungers 6a, 6b engage in the strand produced in the same way as described above. The distance between the division plungers essentially corresponds to the distance between the division points in the sachet 2.

The individual sachets can then be subdivided via a separating device at the division point 8, for example on an extended lower transport means 5b or on a second lower transport means which joins the first lower transport means 5b, or the sachets can be produced as a chain with a specific chain length, i.e. they are either not separated or separated after a specific number of sachets.

As can be seen from FIG. 4, the produced sachets 2 have a rectangular flat shape, i.e. the height u is smaller than the width r. The sachets 2 are bounded at the front and rear by the division points 8a, 8b with a width m, which preferably has half the dimension of the entire division point 8 produced by the division plungers and essentially corresponds to half the width of the division plungers 6a, 6b. The pressed end regions, i.e. the division locations 8a, 8b, which bound the front and rear of the sachets, are flat and extend over the entire width of the sachet. They also have a rectangular shape.

K is, for example, in a range of 15-200 mm, r is preferably in a range of 15-70 mm, u is preferably in a range of 4-40 mm. These dimensions are only exemplary and the disclosure is not limited thereto.

According to another possible embodiment, the wrapping material, e.g. the alginate paste, comprises crushed food products, e.g. pieces of bell pepper. The pieces of bell pepper have a volume of 1-4 mm³, for example. The extrusion gap for the wrapping material must then be adapted accordingly and have a larger gap width than the largest dimension of the food pieces, e.g. the food pieces have a largest dimension of <2 mm and the gap width is then e.g. 2 mm. The proportion of crushed food pieces in the not yet extruded wrapping material, e.g. the paste, is in the range of 10-50 vol. %.

According to a further embodiment, the device has an additional twisting device via which the filling pipe can be twisted around its longitudinal axis. For example, the filling pipe is rotated 0.5-3, preferably more than 1.5 revolutions to create a liquid-tight division between two adjacent packages. Alternating flat division points and twisted, i.e. rounded, division points can then be produced, for example, to create bag-like products.

1. A device for producing sachets filled with liquid or pasty filling material, comprising:
a coextrusion device for coextruding a strand from a wrapping material filled with the filling material; and
opposite circulating division plungers, between which the strand is configured to be transported and which, when the division plungers move towards one another on their orbital path, are configured to strip off the wrapping material at a division point and press the wrapping material to be flat at the division point to form a sachet.

2. The device according to claim 1, wherein the device comprises a transport device with opposing, circulating transport means on each of which a respective division plunger is arranged,
such that during transport of the sachets in a transport direction, the division plungers can further press the wrapping material at the division point.

3. The device according to claim 2, wherein the division plungers each comprise a flat pressing surface in order to press the wrapping material on the division point over the entire surface, smoothly and crease-free.

4. The device according to claim 3, wherein each pressing surface of each division plunger has a length which extends perpendicular to the transport direction of the transport device and which is greater than or equal to a width of the strand.

5. The device according to claim 4, wherein the coextrusion device comprises a filling pipe for discharging the filling material, and an extrusion nozzle associated with the filling pipe and having an annular extrusion gap for discharging the wrapping material.

6. The device according to claim 5, wherein the filling pipe projects over a distance X beyond the extrusion gap in such a way that the wrapping material is extruded through the extrusion gap onto the filling pipe and can solidify along the filling pipe, and the device comprises a lubricant device for supplying a lubricant between the filling pipe and the discharged wrapping material.

7. The device according to claim 5, wherein a width of an outlet opening of the filling pipe is greater than its height, wherein the outlet opening comprises an oval cross-section or a rectangular cross-section with rounded corners.

8. The device according to claim 5, wherein a pipe section is formed on an end of the filling pipe facing the transport device, a width of an outlet opening of which is greater than a diameter of the filling pipe and a height of which is less than a diameter of the filling pipe, wherein a cross-sectional area of the filling pipe and of the formed pipe section are essentially the same.

9. The device according to claim 5, wherein the filling pipe and the transport means are spatially superimposed, such that an outlet opening of the filling pipe is arranged in a deflection area between the transport means.

10. The device according to claim 5, wherein a distance between the opposing circulating transport means at a rear end viewed in the transport direction is smaller, equal to, or greater than at a beginning.

11. The device according to claim 5, wherein a distance from an outlet opening of the filling pipe to a plane E1, which is perpendicular to the transport direction T and on which at least one of front axes around which the transport means circulate is about 5-30 mm.

12. The device according to claim 2, wherein the transport means comprises a lower transport means and an upper transport means that are arranged one above the other and the lower transport means is longer than the upper transport means above it or a further transport means adjoins the lower transport means.

13. The device according to claim 2, wherein the device has a fixing device for applying a fixing agent upstream of the circulating transport means when viewed in the transport direction.

14. The device according to claim 1, wherein the device comprises a separating device which separates successive sachets from one another in an area of the division point, wherein the separating device is integrated in the division plungers or the separating device is a perforating device which perforates the sachets at the division point.

15. The device according to claim 1, wherein a distance between the opposing division plungers is adjustable.

16. A method for producing sachets filled with liquid or pasty filling material, comprising:
extruding a strand of a curable wrapping material filled with a filling material via a coextrusion device and guiding the strand between circulating division plungers, wherein
the circulating division plungers move towards one another, engage in the strand and in the process strip off the filling material from the wrapping material at a division point and press the not yet completely cured wrapping material to be flat at the division point to form a sachet.

17. The method according to claim 16, wherein a transport device with opposing, circulating transport means, on each of which a respective plurality the division plungers are arranged, transports the separated sachets in a transport direction, wherein the division point is further pressed by the division plungers.

18. The method according to claim 16, wherein the sachets are separated at their division point and the separated sachets have a rectangular flat shape, wherein a height of the sachets is smaller than a width and a ratio of the height to the width is in a range of 1:1.5-1:20 and the division points, which seal the sachets at a front and rear, extend over the entire width of the sachet.

19. The method according to claim 16, wherein the wrapping material comprises pieces of a food product.
